(19) United States
(12) Patent Application Publication
(10) Pub. No.: US 2005/0026654 A1
(43) Pub. Date: Feb. 3, 2005

(54) Dynamic application resource management

(75) Inventors: Ricardo Martinez Perez, Plantation, FL (US); Jyh-Han Lin, Coral Springs, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/630,099

(22) Filed: Jul. 30, 2003

(51) Int. Cl. H04Q 7/20

(52) U.S. Cl. 455/556.2

(57) ABSTRACT

A system, method, and computer program product on an electronic device for managing application resources on the electronic device is disclosed. The method on an electronic device includes receiving (404) a command indicating that a user desires to execute an application (350) on the electronic device. The method further includes reading (406) at least one application resource requirement (352) associated with the application (350) and determining (412) whether the at least one application resource requirement (352) can be met by the electronic device. If the at least one application resource requirement (352) can be met by the electronic device, the application (350) on the electronic device is executed (414). If the at least one application resource requirement (352_cannot be met by the electronic device, it is indicated (516) to the user that the application (350) cannot be executed on the electronic device.

### FIELD OF THE INVENTION

The present invention generally relates to the field of information processing systems, and more particularly relates to dynamic application resources management on an information processing system such as wireless messaging devices, personal digital assistants, and computers.

### BACKGROUND OF THE INVENTION

Small consumer electronic devices have enjoyed increasing popularity in recent years. The 1990s has seen the wide acceptance and use of wireless devices, mobile telephones, messaging devices, pagers, laptops, palmtops, handheld computers and PDAs. The Cellular Telecommunications and Internet Association calculates that 120 million Americans own a mobile telephone—about half of the U.S. population. As the development of mobile telephones progresses and the availability of bandwidth increases, many mobile customers are upgrading to phones and phone services with features such as picture messaging, camera attachments and other new designs. As a result, portable consumer electronics in general, and in particular, smartphones (a combination of a pocket or handheld PC and a mobile telephone) have enjoyed increasing popularity in the wireless service industry. Today, smartphones allow a user to perform many functions that can be performed by a desktop PC, such as web browsing, contact information management, and email management, while providing the user with a compact device that doubles as a mobile telephone.

Along with the proliferation of portable electronic devices, the speed of CPUs, DSPs and microprocessors continues to double every couple years. To exploit the maximum performance of CPUs, it is not unusual for application designers, especially in applications such as games, to write custom I/O routines and video refresh routines. The use of custom I/O and refresh routines, although useful, is not without its drawbacks. One drawback, which may be counterintuitive, involves executing older games on faster and more recent electronic devices. Often, these older games will not operate correctly on faster platforms. Screens may refresh too rapidly, making the game unusable.

Additionally, the emergence of smartphones does not come without its drawbacks. The presence of multiple applications on a device that performs many functions, including telephony functions, gives rise to a variety of problems. One problem is that applications are launched on a device without any knowledge of its application resource requirements, such as required I/O bandwidth, required MIPS, required screen refresh rate, required power drain, required memory, and or any other common resource requirement. Having no mechanism for the application to specify the desired resources and how much is needed to safely and properly run the application prior to application start up causes the overall system performance to degrade and, in some cases, to be inoperable.

Another problem is that processors with variable/configurable CPU clock rates do not have an automated way to scale up/down based on the application actual needs, which significantly affects the system power consumption. An example of this is when applications running on a system only require a screen refresh rate of 10 FPS that could be achieved with the processor running at 50 MHz instead of 500 MHz. The current implementations will most likely run at one of the 2 or 4 different predefined clock rates without any association to the actual application needs, which causes a considerable waste of CPU resources and the computing device power consumption.

Yet another problem is that applications developed for phones that operate with processors with 30-60 MHz clocks do not properly run on next generation phones where the clock rates could approach 150 MHz (12 months) to 600 MHz (within 36 months), and 1 GHz within 5 years. Thus, a big percentage of the applications will run too fast to be of any use on future faster platforms.

Current techniques that deal with these problems require hardware and monitoring by the radio operating system. The techniques use prediction to guess the CPU performance needed to meet application needs. This creates several problems. One problem is that the quality of the prediction may be poor, causing more wasted power or a lack of system resources. Another problem is that constant monitoring by the system and dedicated hardware is required, resulting in increased power consumption. Yet another problem is that developers are required to use proprietary APIs within their applications.

Therefore a need exists to overcome the problems with the prior art as discussed above.

### SUMMARY OF THE INVENTION

Briefly, in accordance with the present invention, disclosed is a system, method, and computer program product on a wireless device for managing application resources on an electronic device such as a wireless messaging device, a personal digital assistant (PDA), a cellular telephone, and a computer. The method on a wireless device includes receiving a command indicating that a user desires to execute an application on the electronic device. The method further includes reading at least one application resource requirement associated with the application and determining whether the at least one application resource requirement can be met by the electronic device. If the at least one application resource requirement can be met by the electronic device, the application on the electronic device is executed. If the at least one application resource requirement cannot be met by the electronic device, it is indicated to the user that the application cannot be executed on the electronic device.

In another embodiment of the present invention, the method further includes increasing the clock rate and/or the level of power consumption of the CPU of the electronic device and executing the application on the electronic device. In yet another embodiment of the present invention, the method further includes decreasing the priority level of the application and executing the application on the electronic device. In yet another embodiment of the present invention, the method further includes any one of the following steps: indicating to the user that other applications must be terminated in order to execute the application on the electronic device, indicating to the user that the clock rate and/or the level of power consumption of the CPU of the electronic device must be increased in order to execute the application on the electronic device and indicating to the user that the priority level of the application must be decreased in order to execute the application on the electronic device.

In yet another embodiment of the present invention, an electronic device for managing application resources on the electronic device is disclosed. The electronic device includes an application residing on the electronic device and a command indicating that a user desires to execute an application. The electronic device further includes a file including at least one application resource requirement associated with the application and a processor for determining whether the at least one application resource requirement can be met by the electronic device.

In yet another embodiment of the present invention, the processor further executes the application on the electronic device if the at least one application resource requirement can be met by the electronic device. In yet another embodiment of the present invention, the processor further indicates to the user that the application cannot be executed on the electronic device if the at least one application resource requirement cannot be met by the electronic device.

An advantage of the foregoing embodiments of the present invention is that the electronic device is able to execute the application in such a way as to optimize the utilization of application resources, such as power consumption, clock rate, bandwidth, and application priority level. This results in a more efficient allocation of application resources and a decreased consumption of application resources by the electronic device during execution of the application.

### BRIEF DESCRIPTION OF THE DRAWINGS

FIG. 1 is a block diagram illustrating a conventional wireless communication system.

FIG. 2 is a more detailed block diagram of a conventional wireless communication system.

FIG. 3 is a block diagram illustrating a wireless device for a wireless communication system according to a preferred embodiment of the present invention.

FIG. 4 is an operational flow diagram showing the overall process of one embodiment of the present invention.

FIG. 5 is an operational flow diagram showing the dynamic resource allocation process of one embodiment of the present invention.

FIG. 6 is an operational flow diagram showing the application termination process of one embodiment of the present invention.

FIG. 7 is a block diagram of an information processing system useful for implementing the present invention.

### DETAILED DESCRIPTION

The present invention, according to a preferred embodiment, overcomes problems with the prior art by providing dynamic allocation of resources for executing applications.

General Terminology

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

The term electronic device includes any device capable of running a software application such as a wireless messaging device, a personal digital assistant (PDA), cellular telephone, and computer

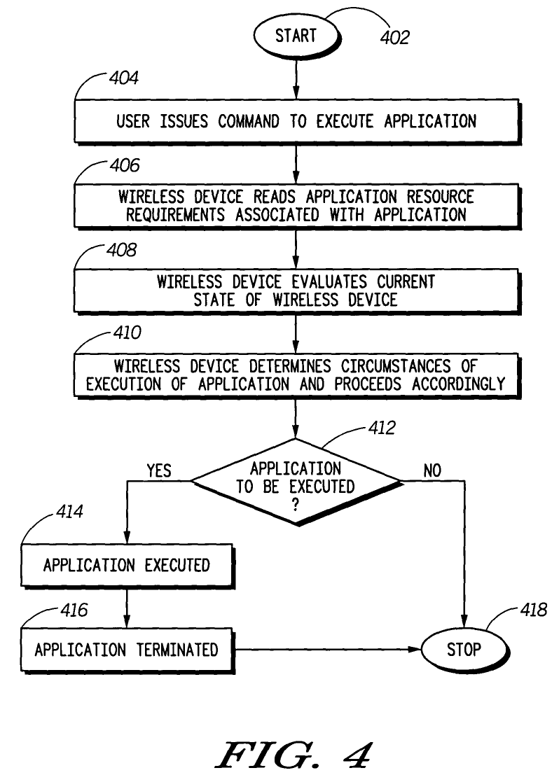

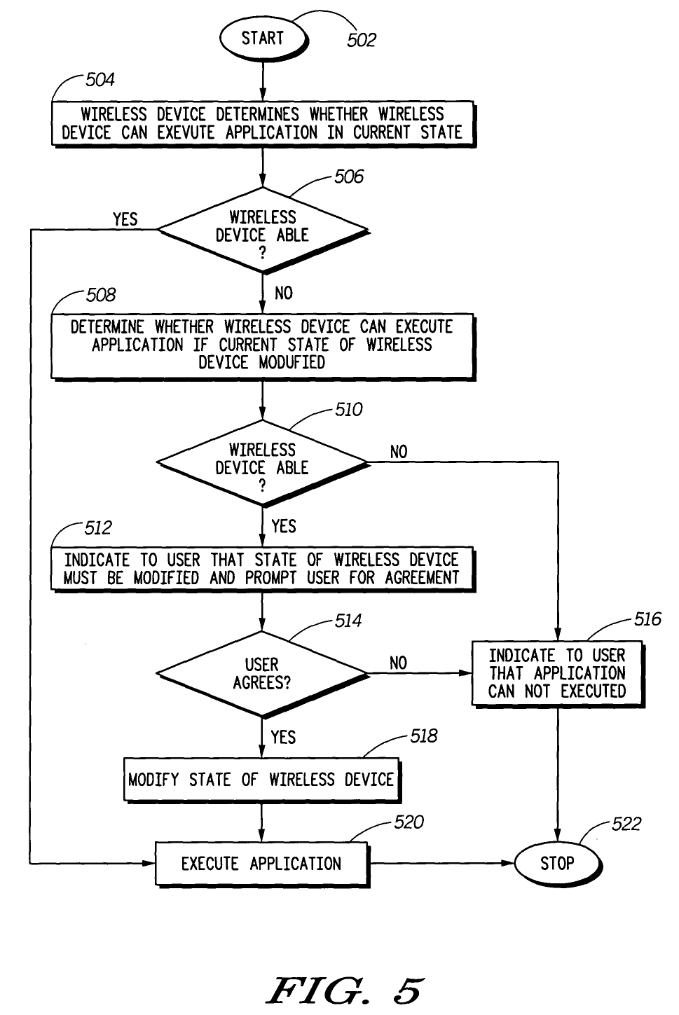

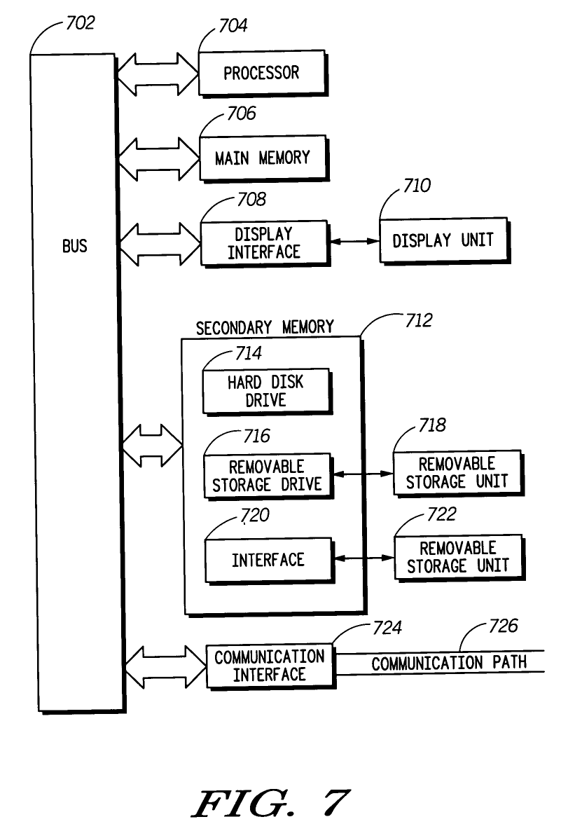

Shown now are two hardware embodiments: a wireless message device of FIGS. 1-4 and a more general electronic device such as a computer in FIG. 7. It is important to note that the operational flow of FIGS. 4-6 are applicable to either of the two exemplary hardware platforms shown. Moreover, as described in the section entitled Computer Readable Medium, the present invention can be realized on a diskette, or other non-volatile storage for loading applications and programs

Wireless Messaging Device Embodiment

FIG. 1 is a block diagram illustrating a conventional wireless communication system. FIG. 1 shows a wireless service provider 102 operating on a wireless network 104, which connects the wireless service provider 102 with wireless devices 106 and 108. The wireless service provider 102 is a first-generation analog mobile phone service, a second-generation digital mobile phone service or a third-generation Internet-capable mobile phone service. The wireless network 104 is a mobile phone network, a mobile text messaging device network, a pager network, or the like. Further, the communications standard of the wireless network 104 of FIG. 1 is Code Division Multiple Access (CDMA), Time Division Multiple Access (TDMA), Global System for Mobile Communications (GSM), General Packet Radio Service (GPRS), Frequency Division Multiple Access (FDMA) or the like.

The wireless network 104 supports any number of wireless devices 106 through 108, which are mobile telephones, smart phones, text messaging devices, handheld computers, pagers, beepers, or the like. A smart phone is a combination of 1) a pocket PC, handheld PC, palm top PC, or Personal Digital Assistant (PDA) and 2) a mobile telephone. More generally, a smartphone is a mobile telephone that has additional application processing capabilities. In another embodiment of the present invention, wireless devices 106 through 108 are wirelessly enabled desktop computers, laptop computers, or palmtop computers. Wireless devices 106 through 108 are described in greater detail below.

The wireless network 104 can also include a wired or wireless network connection (not shown). The network connection comprises a connection to any one or any combination of a Local Area Network (LAN), a Wide Area Network (WAN), a Public Switched Telephone Network (PSTN), a dedicated line, or the like. Such a connection would provide further network access to wireless devices 106 through 108.

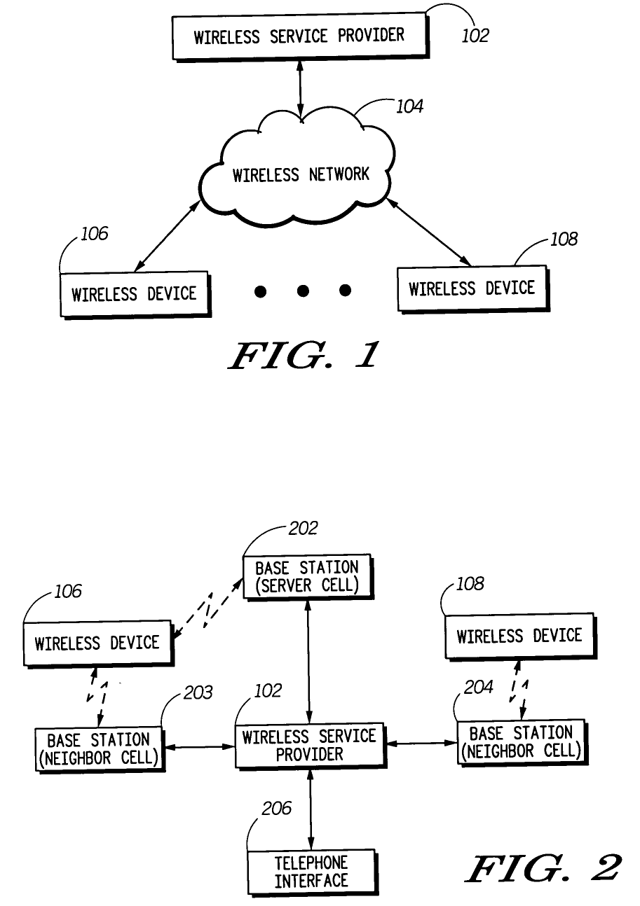

FIG. 2 is a more detailed block diagram of the conventional wireless communication system of FIG. 1. The wireless communication system of FIG. 2 includes the wireless service provider 102 coupled to base stations 202, 203, and 204, which represent the wireless network 104 of FIG. 1. The base stations 202, 203, and 204 individually support portions of a geographic coverage area containing subscriber units or transceivers (i.e., wireless devices) 106 and 108 (see FIG. 1). The wireless devices 106 and 108 interface with the base stations 202, 203, and 204 using a communication protocol, such as CDMA, FDMA, CDMA, GPRS and GSM. The wireless service provider 102 is interfaced to an external network (such as the Public Switched Telephone Network) through a telephone interface 206.

The geographic coverage area of the wireless communication system of FIG. 2 is divided into regions or cells, which are individually serviced by the base stations 202, 203, and 204 (also referred to herein as cell servers). A wireless device operating within the wireless communication system selects a particular cell server as its primary interface for receive and transmit operations within the system. For example, wireless device 106 has cell server 202 as its primary cell server, and wireless device 108 has cell server 204 as its primary cell server. Preferably, a wireless device selects a cell server that provides the best communication interface into the wireless communication system. Ordinarily, this will depend on the signal quality of communication signals between a wireless device and a particular cell server.

As a wireless device moves between various geographic locations in the coverage area, a hand-off or hand-over may be necessary to another cell server, which will then function as the primary cell server. For example, as wireless device 106 moves closer to base station 203, base station 202 hands off wireless device 106 to base station 203. A wireless device monitors communication signals from base stations servicing neighboring cells to determine the most appropriate new server for hand-off purposes. Besides monitoring the quality of a transmitted signal from a neighboring cell server, the wireless device also monitors the transmitted color code information associated with the transmitted signal to quickly identify which neighbor cell server is the source of the transmitted signal.

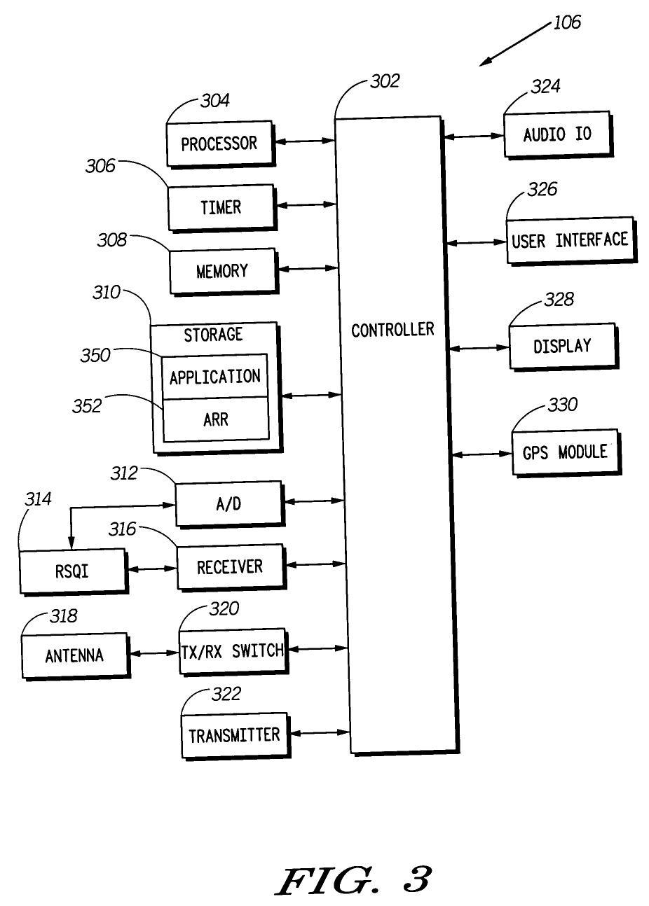

FIG. 3 is a block diagram illustrating a wireless device for a wireless communication system according to a preferred embodiment of the present invention. FIG. 3 shows a mobile telephone wireless device, such as wireless device 106. In one embodiment of the present invention, wireless device 106 is a two-way radio capable of receiving and transmitting radio frequency signals over a communication channel under a communications protocol such as CDMA, FDMA, CDMA, GPRS, GSM or the like.

The wireless device 106 operates under the control of a controller 302, which switches the wireless device 106 between receive and transmit modes. In receive mode, the controller 302 couples an antenna 318 through a transmit/receive switch 320 to a receiver 316. The receiver 316 decodes the received signals and provides those decoded signals to the controller 302. In transmit mode, the controller 302 couples the antenna 318, through the switch 320, to a transmitter 322.

The controller 302 operates the transmitter and receiver according to instructions stored in memory 308. These instructions include a neighbor cell measurement-scheduling algorithm. In preferred embodiments of the present invention, memory 308 comprises any one or any combination of non-volatile memory, Flash memory or Random Access Memory. A timer module 306 provides timing information to the controller 302 to keep track of timed events. Further, the controller 302 utilizes the time information from the timer module 306 to keep track of scheduling for neighbor cell server transmissions and transmitted color code information.

When a neighbor cell measurement is scheduled, the receiver 316, under the control of the controller 302, monitors neighbor cell servers and receives a “received signal quality indicator” (RSQI). An RSQI circuit 314 generates RSQI signals representing the signal quality of the signals transmitted by each monitored cell server. Each RSQI signal is converted to digital information by an analog-to-digital converter 312 and provided as input to the controller 302. Using the color code information and the associated received signal quality indicator, the wireless device 106 determines the most appropriate neighbor cell server to use as a primary cell server when hand-off is necessary.

Processor 304 in FIG. 3 performs various functions such as the telephony functions of the wireless device 106 and the functions of the wireless device 106 attributed to dynamic resource allocation, as described below with reference to FIGS. 4-6. In various embodiments of the present invention, the processor 304 in FIG. 3 comprises a single processor or more than one processor for performing the tasks described below.

FIG. 3 also includes a storage module 310 for storing information that may be used during the overall processes of the present invention. Application 350, in computer readable form, can be stored in storage module 310 for execution by the processor 304 on the wireless device 106.

In one embodiment of the present invention, an application resource requirement (ARR) file 352 associated with the application 350 can also be stored in the storage module 310. ARR file 352 includes data related to the application resource requirements associated with the execution of the application 350 on the wireless device 106. A more detailed description of application resource requirements is provided below. ARR file 352 can be a Java Descriptor file (JAD) or other file typically used for holding metadata pertaining to another file and be stored as part of the file or in a resource directory such as a bat, dat, registry, or other resource file. An exemplary JAD file including power management and performance application resource requirements is shown below.

| | |
|---|---|
| MIDlet-1: AsteroidsGame, | |
| AsteroidsGame.png, | |
| com.mot.h2me.midlets.AsteroidsGame | |
| MIDlet-Jar-Size: 134859 | |
| MIDlet-Jar-URL: AsteroidsGame.jar | |
| MIDlet-Name: AsteroidsGame | |
| MIDlet-Vendor: Motorola, Inc. | |
| MIDlet-Version: 85.00.16 | |
| SMTPServer: idenmoto.com | |
| iDEN-MIDlet-Performance-FPS-TARGET: 12 | // 12 Frames/Second iDEAL |
| iDEN-MIDlet-Performance-MIPS-AVG: 5 | // Average 5 MIPS |
| iDEN-MIDlet-Performance-MIPS_MIN: 3 | // Need at least 3 MIPS to Run |
| iDEN-MIDlet-Performance-MIPS_BACKG: 0.3 | // Need at least 0.3 MIPS |
| | // to Run when used in |
| | // Background mode. |
| iDEN-MIDlet-Performance-Class: None | // Not performance critical App |
| iDEN-MIDlet-Performance-IO: None | // No a factor for this App |
| MIDlet-1: MP3AUDIOPlayer, MP3AUDIOPlayer.png, | |
| com.mot.j2me.midlets.MP3AUDIOPlayer | |
| MIDlet-Jar-Size: 234200 | |
| MIDlet-Jar-URL: MP3AUDIOPlayer.jar | |
| MIDlet-Name: MP3AUDIOPlayer | |
| MIDlet-Vendor: Motorola, Inc. | |
| MIDlet-Version: 85.00.11 | |
| SMTPServer: idenmoto.com | |
| iDEN-MIDlet-Performancer-FPS-TARGET: 15 | // 12 Frames/Second iDEAL |
| iDEN-MIDlet-Performance-MIPS-AVG: 50 | // Average 50 MIPS |
| iDEN-MIDlet-Performance-MIPS_MIN: 35 | // Need at least 35 MIPS to Run |
| iDEN-MIDlet-Performance-MIPS_BACKG: 10 | // Need 10 MIPS when placed on |
| | // Background Mode |
| iDEN-MIDlet-Performance-Class: Medium | // Relatie Performance App |
| iDEN-MIDlet-Performance-IO_SDIO: 44kb | // Need BW from SDIO port |

In another embodiment of the present invention, the information in the ARR file 352 can be embedded in the computer readable medium or computer program product of the application 350.

The wireless device 106 of FIG. 3 further includes an audio input/output module 324 for allowing the input of audio into the wireless device 106 and the output of audio for listening by a user. Also included is a user interface 326 for allowing a user to interact with the wireless device 106, such as modifying address book information, interacting with call data information and making/answering calls. Wireless device 106 further includes a display 328 for displaying information to the user of the wireless device 106.

FIG. 3 also shows an optional Global Positioning System (GPS) module 330 for determining location and/or velocity information of the wireless device 106. This module 330 uses the GPS satellite system to determine the location and/or velocity of the wireless device 106. Alternative to the GPS module 330, the wireless device 106 may include alternative modules for determining the location and/or velocity of wireless device 106, such as using cell tower triangulation and assisted GPS.

Operational Flows

FIG. 4 is an operational flow diagram showing the overall process of one embodiment of the present invention. The operational flow diagram of FIG. 4 shows an overall process of how the wireless device 106, computer readable medium, or computer in FIG. 7 or any other electronic device, evaluates the current state of the electronic device and decides how an application 350 will or will not be executed by the electronic device. The operational flow diagram of FIG. 4 begins with step 402 and flows directly to step 404.

In step 404, a user issues a command indicating a desire to execute an application 350 on the electronic device. This may consist of clicking a cursor or other graphical representation on a button or other widget on a display of the electronic device or other event such as inserting a DVD, CD or other computer readable medium. This may consist of clicking a button or other mechanical device on the electronic device. In this step, the electronic device receives the command and proceeds to process it.

In step 406, the electronic device reads the application resource requirement (ARR) file 352 associated with the application 350, which is stored in the storage module 310. ARR file 352 includes data related to the application resource requirements associated with the execution of the application 350 on the electronic device. A more detailed description of application resource requirements, and their effect on the electronic device during execution, is provided below.

An application resource requirement includes any of the following: average Millions of Instructions per Second (MIPS), lowest MIPS, peak MIPS, screen refresh rate, I/O bandwidth and application priority level. Average MIPS refers to the average number of MIPS necessary to execute the application 350. Lowest MIPS refers to the lowest number of MIPS necessary to execute the application 350 in reduced performance mode. Peak MIPS refers to the highest number of MIPS encountered during the execution of the application 350. Screen refresh rate refers the rate at which the display or screen 328 is refreshed during the execution of the application 350. I/O bandwidth refers the amount of bandwidth in the electronic device that is required for execution of the application 350. Application priority level is an indicator of the criticality of the application 350. In short, the application priority level indicates how important it is to run the application 350 and/or how important it is to run the application 350 in regular (not reduced) performance mode. This invention is not limited in this regard as the ARR file 352 may contain any other suitable perimeters related to application resource requirements.

The average MIPS and lowest MIPS application resource requirements indicate the average processor load of the application 350 and the minimum processor load at which the application 350 will work with reduced performance, respectively. Using this value, the present invention may carry out a variety of options as described below.

One option is to increase the processor clock speed, which may require increasing supply voltage. This would allow the operating system of the electronic device to have the added MIPS required to run the application 350. If this option is taken, upon termination of the application 350, the processor clock speed is optionally returned to its original state.

Another option is to instruct or indicate to the user that running the application 350 is not possible without exiting current applications. Yet another option is to instruct or indicate to the user that the application 350 requires the processor to move to a higher level of power consumption. If this option is taken, upon termination of the application 350, the processor power consumption level is optionally returned to its original state.

Yet another option is to instruct or indicate to the user that the application 350 will be run in reduced performance mode. Subsequently, the application 350 is executed as a low priority application. Yet another option is to instruct or indicate to the user which applications could be terminated that will allow the electronic device to maintain the current power consumption mode while executing the application 350.

The peak MIPS application resource requirement indicates the highest processor load of the application 350 and the percentage of time that load must be sustained Using this value, the present invention may carry out a variety of options.

One option is to increase the processor clock speed, which may require increasing supply voltage. This would allow the operating system of the electronic device to have the added MIPS required to run the application 350 at its peak MIPS requirement or at a fraction of that, depending on the percentage of time the peak lead must be sustained. If this option is taken, upon termination of the application 350, the processor clock speed is optionally returned to its original state. In an alternate embodiment, the processor clock speed may be reduced and/or the supply voltage reduced if the application 350 can be run at a lower clock speed.

Another option is to instruct or indicate to the user that running the application 350 is not possible without exiting current applications. Yet another option is to instruct or indicate to the user which applications could be terminated that will allow the electronic device to maintain the current power consumption mode while executing the application 350. Yet another option is to instruct or indicate to the user that running the application 350 is simply not possible.

The screen refresh rate application resource requirement indicates the rate at which the display or screen 328 is refreshed during the execution of the application 350. Sometimes the application MIPS are allocated in bursts in which the average MIPS are not a good measure of the performance at which the application 350 must be executed. In this case, and in cases where the developer knows the desired application screen refresh or the user wants to set the screen refresh rate manually, this application resource requirement becomes important. Using this value, the present invention may carry out a variety of options.

One option is to halt execution of the application 350 after each display update to achieve the desired screen refresh rate. Another option is to instruct or indicate to the user that running the application 350 is not possible at the desired screen refresh rate without exiting current applications. Yet another option is to instruct or indicate to the user which applications could be terminated that will allow the electronic device to maintain the desired refresh rate while executing the application 350. Yet another option is to allow the user the option of executing the application 350 at a reduced refresh rate.

Yet another option is to increase the processor clock speed, such as increasing supply voltage or changing a setting on the processor. This would allow the operating system of the electronic device to have the added MIPS required to run the application 350 at the desired refresh rate. If this option is taken, upon termination of the application 350, the processor clock speed is optionally returned to its original state.

Yet another option is to instruct or indicate to the user that the application 350 requires the processor to move to a higher level of power consumption. If this option is taken, upon termination of the application 350, the processor power consumption level can optionally be returned to its original state.

The I/O bandwidth application resource requirement indicates the amount of bandwidth that is necessary in the file system, the network connection, a peripheral or system memory of the electronic device that is required for execution of the application 350. In this embodiment, the application 350 is used to determine if enough resources are available on the electronic device. For example, assume that the user is playing an MPEG4 video clip with MP3 audio from a Secure Digital I/O (SDIO) slot and the user tries to execute an application 350 that requires access to the SDIO card to read data. Then, if there is not enough bandwidth available to run both applications, the present invention should alert the user of the problem rather than affecting the performance of the MPEG4 video clip. Furthermore if the priority level of the MPEG4 player is high, then low priority applications will not be allowed to run.

The application priority level application resource requirement indicates the criticality of the application 350. In short, the application priority level indicates how important it is to run the application 350 and/or how important it is to run the application 350 in regular (not reduced) performance mode. There are applications that the user may be running or desires to run that cannot accept any performance degradation such as a G.711 audio codec for Voice over IP. Such an application is time critical (high priority level) and any performance degradation will not be accepted. Knowing this, the present invention provides a resource monitoring function when loading and/or executing other applications.

Applications that are not of high priority level should not affect the performance of high priority level applications. That is, if a high priority level application is running, a new low priority level application will not be loaded/started if that will affect the performance of a high priority level application. In the same way, if the user loads a high priority level application, any low priority level application may be affected but not the high priority level application.

The application priority level application resource requirement, in one embodiment further indicates the criticality of an application by monitoring background/foreground mode information for the application. Many applications operate in two primary modes, foreground mode and background mode, and switches between the modes when multiple applications (such as Java midlets) are running concurrently. Traditionally, when an application is running in foreground mode, it requires higher processor resources than when it is on background mode. An application is placed by the user in background mode by user choice through different methods (for example, a user switching to a different but concurrent application) or by the present invention when the resources are needed by a higher priority level application. The background resource information is used by the present invention to notify the application that it has lost focus/priority and/or to decide whether or not an application will be totally suspended or moved to a background state that will still allow the application to operate but with significantly reduced processor resources.

Operational Flows for Various Hardware Embodiments

Returning to FIG. 4, in step 408, the electronic device evaluates the current state of the electronic device. In this step, the electronic device determines the current processing status of the electronic device, such as the power consumption level of the processor 304, the memory usage level of the memory 308, the processor usage level of the processor 304 and other indicators describing the current state of the electronic device. This allows the electronic device to determine what the wireless device is capable of executing in the next step.

In step 410, the electronic device determines the circumstances of execution of the application 350 and proceeds accordingly. This step involves determining how the electronic device can or cannot proceed in the execution or non-execution of the application 350. This step is described in more detail with reference to FIG. 5 below.

In step 412, the wireless device determines whether the application 350 will be executed, as established above in step 410. If the application 350 is executed, control flows to step 414. If the application 350 is not executed, control flows to step 418. In step 414, the application 414 is executed. In step 416, the application 350 is terminated. In step 418, the control flow of FIG. 5 stops.

One advantage of the embodiments of the present invention is that the electronic device is able to execute the application in such a way as to optimize the utilization of application resources, such as power consumption, clock rate, bandwidth, and application priority level. This results in a more efficient allocation of application resources and a decreased consumption of application resources by the electronic device during execution of the application.

FIG. 5 is an operational flow diagram showing the dynamic resource allocation process of one embodiment of the present invention. The operational flow diagram of FIG. 5 shows an overall process of how the electronic device decides how an application 350 will or will not be executed by the electronic device. The operational flow diagram of FIG. 5 describes in more detail the process described in step 410 above. The operational flow diagram of FIG. 5 begins with step 502 and flows directly to step 504.

In step 504, the electronic device determines whether the electronic device can execute the application 350 in its current state, while maintaining its current power consumption levels, maintaining its current processor clock speed and maintaining the performance of other applications executing on the electronic device. In short, the electronic device determines whether the electronic device can execute the application 350 without affecting other aspects. In step 506, if the result of this determination is positive, then control flows to step 520. If the result of this determination is negative, then control flows to step 508.

In step 508, the electronic device determines whether the electronic device can execute the application 350 by modifying its current state, such as modifying its current power consumption levels, modifying its current processor clock speed or modifying the performance of other applications executing on the electronic device. Examples of how the current state of the electronic device can be modified and how the performance of other applications executing on the electronic device can be modified are described in greater detail above. In step 510, if the result of this determination is positive, then control flows to step 512. If the result of this determination is negative, then control flows to step 516.

In optional step 512, the electronic device indicates to the user that the state of the wireless device must be modified and prompts the user for agreement. For example, the present invention may prompt the user to agree with an increase in power consumption levels or an increase in processor clock speed. Further examples of how the current state of the electronic device can be modified are described in greater detail above. In step 514, if the user agrees, then control flows to step 518. If the user does not agree, then control flows to step 516.

In step 518, the state of the electronic device is modified as described in step 512 above. In step 520, the application 350 is executed. In step 516, the electronic device indicates to the user 106 that the application 350 cannot be executed. In step 522, the control flow of FIG. 5 stops.

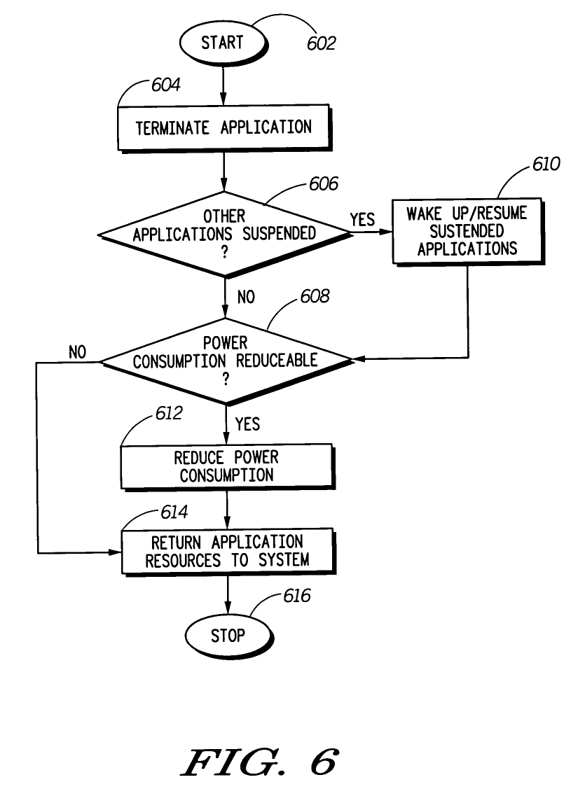

FIG. 6 is an operational flow diagram showing the application termination process of one embodiment of the present invention. The operational flow diagram of FIG. 6 shows an overall process of actions taken after an application 350 is terminated on the electronic device. The operational flow diagram of FIG. 6 describes in more detail the process described in step 416 above. The operational flow diagram of FIG. 6 begins with step 602 and flows directly to step 604.

In step 604, the application 350 is terminated. In step 606, the electronic device determines whether other applications were suspended when the application 350 was executed. If the result of this determination is positive, then control flows to step 610. If the result of this determination is negative, then control flows to step 608.

In step 608, the electronic device determines whether the power consumption level of the electronic device can be reduced. For example, if the power consumption levels of the electronic device were increased to execute application 350, then upon termination of the application 350, the power consumption levels of the electronic device could be decreased. If the result of this determination is positive, then control flows to step 612. If the result of this determination is negative, then control flows to step 614. At 610, the suspend application can be resumed and the application proceeds to step 608.

In step 612, the power consumption levels of the electronic device are decreased as much as is viable. In step 614, the application resources that were utilized by the application 350 are returned to the operating system of the electronic device. In step 616, the control flow of FIG. 6 stops.

The present invention can be realized in hardware, software, or a combination of hardware and software on the wireless devices 106 through 108 or any combination of the two. A system according to a preferred embodiment of the present invention can be realized in a centralized fashion in one information processing system, or in a distributed fashion where different elements are spread across several interconnected systems. Any kind of information processing system—or other apparatus adapted for carrying out the methods described herein—is suitable. A typical combination of hardware and software could be a general-purpose computer system with a computer program that, when being loaded and executed, controls the computer system such that it carries out the methods described herein.

Computer Readable Medium

An embodiment of the present invention can also be embedded in a computer program product that includes all the features enabling the implementation of the methods described herein, and which, when loaded in a system, is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A system may include, inter alia, one or more information processing systems and/or computers and at least a machine-readable or computer-readable medium, allowing a system, to read data, instructions, messages or message packets, and other information from the machine-readable or computer-readable medium. The machine-readable or computer-readable medium may include non-volatile memory, such as ROM, Flash memory, Disk drive memory, CD-ROM, and other permanent storage. Additionally, a machine-readable or computer-readable medium may include, for example, volatile storage such as RAM, buffers, cache memory, and network circuits. Furthermore, the machine-readable or computer-readable medium may include information in a transitory state medium such as a network link and/or a network interface, including a wired network or a wireless network, that allow a computer system to read such computer-readable information.

Computer Hardware Embodiment

The invention is not limited to a wireless device 106 as described above. Other general-purpose computers and information processing system are suitable platform on which the present invention can be implemented. An exemplary general-purpose computer is now described.

FIG. 7 is a block diagram of a computer system useful for implementing an embodiment of the present invention. The computer system of FIG. 7 includes multiple processors, such as processors 704. The processors 704 are connected to a communication infrastructure 702 (e.g., a communications bus, cross-over bar, or network). At least one cache is also connected to the communication infrastructure 702. Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, magnetic tape, optical disk, etc., which is read by and written to by removable storage drive 716. As will be appreciated, the removable storage unit 718 includes a computer usable storage medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a telephone line, a cellular telephone link, an RF link, and/or other communications channels.

In this document, the terms “computer program medium,” “computer-usable medium,” “machine-readable medium” and “computer-readable medium” are used to generally refer to media such as main memory 706 and secondary memory 712, removable storage drive 716, a hard disk installed in hard disk drive 714, and signals. These computer program products are means for providing software to the computer system. The computer-readable medium allows the computer system to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may include computer-readable information in a transitory state medium such as a network link and/or a network interface, including a wired network or a wireless network, that allow a computer to read such computer-readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method on an electronic device for managing application resources on the electronic device, the method comprising:
receiving a command indicating to execute an application on an electronic device;
reading at least one application resource requirement associated with the application; and
determining whether the at least one application resource requirement can be met by the electronic device.

2. The method of claim 1, wherein the electronic device is any one of a mobile telephone, a mobile pager, a wireless messaging device, a computer, a personal digital assistant, and a mobile communication system.

3. The method of claim 1, wherein the electronic device is a portable device, and wherein the at least one application resource requirement includes at least one of:
average MIPS;
lowest MIPS;
peak MIPS;
screen refresh rate;
I/O bandwidth; and
priority level.

4. The method of claim 1, further comprising the steps of:
wherein if the at least one application resource requirement can be met by the electronic device, executing the application on the electronic device; and
wherein if the at least one application resource requirement cannot be met by the electronic device, indicating to the user that the application cannot be executed on the electronic device.

5. The method of claim 4, further comprising the steps of:
increasing at least one of the clock rate and the level of power consumption of the CPU of the electronic device and executing the application on the electronic device.

6. The method of claim 4, further comprising the steps of:
decreasing at least one of the clock rate and the level of power consumption of the CPU of the electronic device and executing the application on the electronic device.

7. The method of claim 4, further comprising the step of:
decreasing the priority level of the application and executing the application on the electronic device.

8. The method of claim 4, further comprising any one of the following steps:
indicating to the user that other applications must be terminated in order to execute the application on the electronic device;
indicating to the user that at least one of the clock rate and the level of power consumption of the CPU of the electronic device must be increased in order to execute the application on the electronic device; and
indicating to the user that the priority level of the application must be decreased in order to execute the application on the electronic device.

9. A computer readable medium including computer instructions on an electronic device for managing application resources on the electronic device, the computer instructions including instructions for:
receiving a command on an electronic device to execute an application;
reading at least one application resource requirement associated with the application; and
determining whether the at least one application resource requirement can be met by the electronic device.

10. The computer readable medium of claim 9, wherein the electronic device is any one of a mobile telephone, a mobile pager, a wireless messaging device, and a mobile communication system.

11. The computer readable medium of claim 9, wherein the electronic device is a portable device, and wherein the at least one application resource requirement includes at least one of:
average MIPS;
lowest MIPS;
peak MIPS;
screen refresh rate;
I/O bandwidth; and
priority level.

12. The computer readable medium of claim 9, further comprising instructions for:
wherein if the at least one application resource requirement can be met by the electronic device, executing the application on the electronic device; and
wherein if the at least one application resource requirement cannot be met by the electronic device, indicating to the user that the application cannot be executed on the electronic device.

13. The computer readable medium of claim 12, further comprising instructions for:
increasing at least one of the clock rate and the level of power consumption of the CPU of the electronic device and executing the application on the electronic device.

14. The computer readable medium of claim 12, further comprising instructions for:
decreasing at least one of the clock rate and the level of power consumption of the CPU of the electronic device and executing the application on the electronic device.

15. The computer readable medium of claim 12, further comprising instructions for:
decreasing the priority level of the application and executing the application on the electronic device.

16. The computer readable medium of claim 12, further comprising any one of the following instructions:
indicating to the user that other applications must be terminated in order to execute the application on the electronic device;
indicating to the user that at least one of the clock rate and the level of power consumption of the CPU of the electronic device must be increased in order to execute the application on the electronic device; and
indicating to the user that the priority level of the application must be decreased in order to execute the application on the electronic device.

17. An electronic device for managing application resources on the electronic device, comprising:
an application residing on the electronic device;
a command indicating that a user desires to execute an application;
a file including at least one application resource requirement associated with the application; and
a processor for determining whether the at least one application resource requirement can be met by the electronic device.

18. The electronic device of claim 17, wherein the electronic device is any one of a mobile telephone, a mobile pager, a wireless messaging device, and a mobile communication system.

19. The electronic device of claim 17, wherein the at least one application resource requirement includes at least one of:
average MIPS;
lowest MIPS;
peak MIPS;
screen refresh rate;
I/O bandwidth; and
priority level.

20. The electronic device of claim 19, wherein the processor further:
executes the application on the electronic device if the at least one application resource requirement can be met by the electronic device; and
indicates to the user that the application cannot be executed on the electronic device if the at least one application resource requirement cannot be met by the electronic device.

21. The electronic device of claim 20, wherein the processor further:
increases at least one of the clock rate and the level of power consumption of the CPU of the electronic device and executes the application on the electronic device.

22. The electronic device of claim 20, wherein the processor further:
decreases at least one of the clock rate and the level of power consumption of the CPU of the electronic device and executes the application on the electronic device.

23. The electronic device of claim 20, wherein the processor further:
decreases the priority level of the application and executes the application on the electronic device.
